(19) United States
(12) Patent Application Publication
(10) Pub. No.: US 2008/0238290 A1
(43) Pub. Date: Oct. 2, 2008

(54) Low Pressure Mercury Vapor Fluorescent Lamps

(75) Inventors: Gary Sigai, Salina, KS (US); Brett Carter, Salina, KS (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,491

(22) PCT Filed: Jan. 27, 2005
(86) PCT No.: PCT/IB2005/050370

§ 371 Date: Jul. 27, 2006

Related U.S. Application Data
(60) Provisional application No. 60/540,707, filed on Jan. 30, 2004.

(51) Int. Cl. H01J 1/62; H01J 17/20; C09K 11/08

(52) U.S. Cl. 313/486; 313/642; 252/301.4 R

(57) ABSTRACT

A low mercury consumption electric lamp is provided having a layer of a luminescent material comprising a phosphor derived from a mixture of a mixture of a cool-white calcium halophosphate, a red-emitting yttrium oxide (YOX), a green-emitting cerium, terbium lanthanum phosphate (LAP), and a blue-emitting europium-activated barium magnesium hexa-aluminate (BAM).

This application is related to U.S. application Ser. No. 10/259,713 filed Sep. 27, 2002 of Gary Sigai et al., “Low Pressure Mercury Vapor Fluorescent Lamps”, commonly assigned herewith, the disclosure of which is incorporated by reference.

This invention relates to low-pressure mercury vapor fluorescent lamps.

Low pressure mercury vapor lamps, more commonly known as fluorescent lamps, have a lamp envelope with a filling of mercury and rare gas to maintain a gas discharge during operation. The radiation emitted by the gas discharge is mostly in the ultraviolet (UV) region of the spectrum, with only a small portion in the visible spectrum. The inner surface of the lamp envelope has a luminescent coating, often a blend of phosphors, which emits visible light when impinged by the ultraviolet radiation.

There is an increase in the use of fluorescent lamps because of reduced consumption of electricity. To further reduce electricity consumption, there is a drive to increase efficiency of fluorescent lamps, referred to as luminous efficacy which is a measure of the useful light output in relation to the energy input to the lamp, in lumens per watt (LPW).

Thus, more efficient and longer life fluorescent lamps are desired. However, a significant excess of mercury is introduced into the lamp to meet desired long lamp lifetime of up to 20,000 hours or more. This is necessary because different lamp components, such as the glass envelope, phosphor coatings and electrodes use up the mercury in the lamp. Such increased use of mercury is not desirable and is detrimental to the environment. Accordingly, there is a drive to reduce mercury consumption in fluorescent lamps without a reduction in the lamp life.

An example of a successful lamp with reduced mercury consumption is the Alto cool-white Econowatt fluorescent lamp. These lamps use small-particle cool-white calcium halophosphate phosphor having an average particle size of about 8 to 12 microns and are doped with less mercury than other lamps to meet the requirement of the Toxic Characteristics Leaching Procedure (TCLP) of the United States Environmental Protection Agency for non-hazardous waste. To continue to meet the rated life of these lamps, it is essential that the lamp and its components have low mercury consumption.

Similarly, fluorescent lamps of Daylight/Daylight Deluxe color have used a large-particle blue-halo calcium halophosphate phosphor as part of a two-component blend that uses a standard white phosphor or a warm-white phosphor as the other component. These lamps are doped with less mercury to meet the TCLP requirement for non-hazardous waste. In U.S. application Ser. No. 10/259,713 referred to above, fluorescent lamps are disclosed having a cool-white color with reduced mercury consumption in which a calcium-yellow calcium halophosphate phosphor is used in a mixture of phosphors comprising about 41% of the calcium-yellow calcium halophosphate phosphor. Such phosphor blends result in lamps having: reduced mercury content that pass the TCLP standards, excellent long-life characteristics, etc. However, the phosphor blends from which the lamps are produced are dependent on the presence of calcium yellow halophosphate as a component, and calcium yellow halophosphate is not readily available commercially. There is therefore a continued need for fluorescent lamps with reduced mercury that pass the TCLP standards and that are derivable from components that are readily commercially available.

An object of the present invention is to provide fluorescent lamps of lite-white color with reduced mercury consumption. (The term “lite-white” or “lite white” refers to a color of light from an energy conserving fluorescent lamp which has a high lumen output, typically an output higher than the output from a cool white color fluorescent lamp.)

Another object of the invention is to provide phosphor blends that are useful in the manufacture of such fluorescent lamps of lite-white color with reduced mercury consumption.

Yet another object of the present invention is to provide alternate and improved phosphor blends (compared to such blends derived from calcium yellow halophosphate) that provide lamps having improved performance at an acceptable cost, and that also provide fluorescent lamps with reduced mercury that pass the TCLP standards, all such phosphor blends and lamps derived therefrom being derived from components that are readily commercially available.

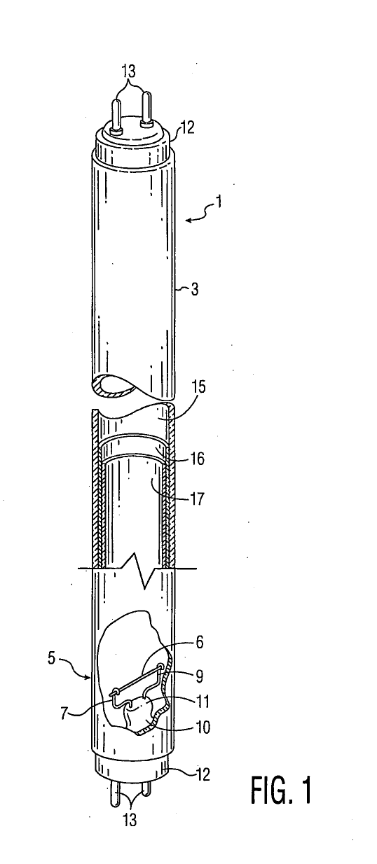

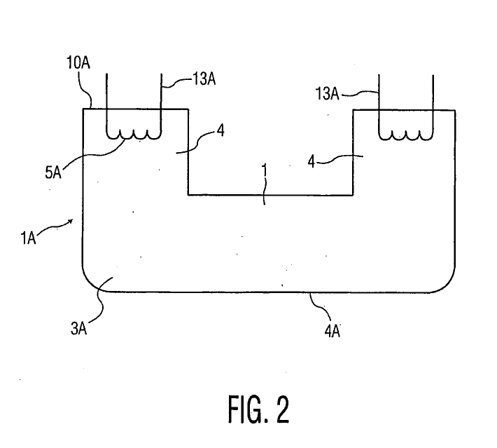

These and other objects of the invention are accomplished by providing an electric lamp having an envelope with an inner surface and at least one electrode, preferably electrodes located at both ends of the envelope tube. The lamp may be a straight fluorescent tube, for example of the type as illustrated in the embodiment of the invention shown in FIG. 1 such as T12 straight Econowatt lamps, or it may be a lamp that includes an envelope of convoluted configuration to a desired shape such as an envelope having at least two straight leg segments joined by a U-bent section as illustrated in the embodiment of the invention shown schematically in FIG. 2 or as in PL lamps, Circleline lamps, SLS lamps, etc. In either embodiment, the electrodes transfer electric power to generate ultraviolet radiation in the envelope which is filled with mercury and a charge sustaining gas. Optionally, as in the case of the straight envelope fluorescent lamps, the inner surface of the envelope may be pre-coated with a metal oxide layer, such as an aluminum oxide layer, to reflect ultraviolet radiation back into the envelope. Such pre-coats are not customarily used in the case of lamps with convoluted envelopes although a flexible pre-coat may be used in the case of SLS lamps as mentioned further hereinbelow. Optionally also, a semiconductive precoat of tin oxide can be applied between the envelope and the precoat layer as a starting aid.

A phosphor layer is formed over the inner surface, pre-coated or not, to convert the ultraviolet radiation to visible list. In conventional lamps, the phosphor layer for a conventional F34T12 straight Econowatt fluorescent lamp is preferably a small particle-sized cool-white calcium halophosphate phosphor formed from a coating which comprises calcium halophosphate activated with manganese and antimony. Similarly the phosphor layer for a conventional U-bend fluorescent lamp of cool-white color contains a small particle-sized two phosphor mix of about 50% large particle cool-white calcium halophosphate activated with antimony and manganese, and about 50% fines (particles smaller than average in a mixture of particles varying in size) of cool-white calcium halophosphate activated with manganese and antimony. The fines are normally used to achieve good adhesion particularly in the convoluted or bent areas between the glass layer or coatings thereon and the phosphor layer.

We have previously discovered that the color obtained from the conventional large particle phosphor blend can be achieved by a phosphor derived from a mixture of fines of warm-white calcium halophosphate phosphor, small-particle blue-halo calcium halophosphate phosphor, and calcium-yellow calcium halophosphate phosphor. It has been found further that using this phosphor blend makes it possible to achieve good adhesion in the manufacture of convoluted lamps of the U-bend type while using low mercury doses in the fluorescent lamp making it environmentally benign. Such phosphors form the subject of our prior application Ser. No. 10/259,713, referred to above.

According to the present invention, a novel lite-white fluorescent lamp is provided having a phosphor that comprises a mixture of a cool-white halophosphate, a red-emitting YOX, a green-emitting LAP, and a blue-emitting BAM.

The components of the phosphor blend may be selected from components that are well known in the art.

The cool-white halophosphate component may be, for example, a calcium fluorochlorophosphate (apatite) doped with antimony and manganese with an emission of a nominal color point of about 4100K, and having the general formula Ca₅(PO₄)₃FCl:Sb,Mn; the red-emitting YOX component is for example trivalent yttrium oxide activated with europium having the general formula Y₂O₃:Eu; the green-emitting LAP component may be, for example cerium, terbium lanthanum phosphate having the general formula LaPO₄:Ce,Th; and the blue-emitting BAM component may be for example divalent europium-activated barium magnesium hexa-aluminate having the general formula BaMgAl₁₁O₁₇:Eu.

In other phosphor blends within the scope of the invention, a CAT component, for example, cerium, terbium magnesium hexa-aluminate, having the general formula: (Ce,Tb)MgAl₁₁O₁₉ or a CBT component, for example cerium, terbium, gadolinium pentaborate having the general formula (Ce, Gd) MgB₅O₁₀:Tb may be substituted for the green-emitting LAP component. Also, a SCA component, for example divalent europium-activated chloro-strontium, calcium, barium phosphate having the general formula: (Sr,Ca,Ba)₅(PO₄)₃Cl:Eu, or a SCAP component, for example divalent europium activated strontium chlorophosphate (apatite) having the general formula: Sr₅(PO₄)₃Cl:Eu may be substituted for the BAM component described above.

Exemplary lite-white phosphor blends are provided which may comprise:
(1) from about 85% to about 96%, preferably about 94%, of a cool-white halophosphate phosphor component;
(2) from about 1.6% to about 5.8%, preferably about 2.3%, of red-emitting YOX component;
(3) from about 1.7% to about 6.5%, preferably about 2.6%, of a green-emitting LAP component; and
(4) from about 0.7% to about 2.7%, preferably about 1.1% of a blue-emitting BAM component,
   wherein the percentages are percentages by weight, and the total percentage of the components is equal to 100%.

Such phosphor blends result in low-mercury consuming lamps. Such lamps are comparable to low mercury Philips Alto lamps and permit use of reduced amounts of mercury when compared to commercially available lamps (other, than the Philips Alto lamps) produced with other phosphors in which more mercury is required. In addition, lamps derived from the novel phosphor blends of this invention exhibit a higher color rendering index (CRI) than conventional cool-white and lite-white lamps (at the lite-white color point). For example, lamps derived from a single component cool-white phosphor exhibited a CRI of 62; lamps derived from a lite-white formulation comprising calcium yellow and BAM exhibited a CRI of 51; and lamps derived from a novel lite-white phosphor blend of the invention had a CRI of 64. Moreover, lamps of the invention may be produced using a reduced lamp powder weight and result in a higher lumen output when compared to lamps derived from a lite-white formulation comprising calcium yellow and BAM.

Mercury consumption is determined by the quantity of mercury which is bound on lamp components during operation of the lamp and is thus no longer available for operation of the lamp. In the present invention, it is possible to have reduced amounts of mercury doped in fluorescent lamps and preferably in cool-white U-bend fluorescent lamps, making such lamps environmentally benign and TCLP compliant.

Lamps derived from such phosphors of the invention also exhibit excellent long-life characteristics.

Thus the invention in preferred embodiments encompasses an electric lamp which comprises:

a lamp envelope having an inner surface;

means within the lamp envelope for generating ultraviolet radiation; and

a layer of a luminescent material that includes a phosphor that comprises a mixture of a cool-white halophosphate, a red-emitting YOX, a green-emitting LAP, and a blue-emitting BAM.

FIG. 1 is a perspective view of one embodiment of a fluorescent lamp according to the invention, partly in cross-section, partly broken away;

FIG. 2 is a sectional view of a U-bend fluorescent lamp according to a second embodiment of the invention.

The figures are diagrammatic and not to scale.

The invention will be better understood with reference to the details of specific embodiments that follow:

With reference to FIG. 1, there is illustrated a low pressure mercury vapor fluorescent lamp 1 with an elongated, straight lamp vessel, or bulb, 3. The bulb is of a conventional soda-lime glass. The lamp includes an electrode mount structure 5 at each end which includes a coiled tungsten filament 6 supported on conductive feed-throughs 7 and 9 which extend through a glass press seal 11 in a mount stem 10. The mount stem is of a conventional lead-containing glass. The stem 10 seals the envelope in a gas tight manner. The leads 7, 9 are connected to the pin-shaped contacts 13 of their respective bases 12 fixed at opposite ends of the lamp.

Further and optionally, a semiconductive precoat layer can be used between the inner surface 15 and the precoat 16. Optionally also, the inner surface 15 of the outer envelope 3 is provided with a mercury-protective layer or undercoat 16. The layer 16 may be provided to reduce the rate of mercury depletion caused by reactions with the glass of the envelope. The layer 16 may be an oxide formed from the group consisting of magnesium, aluminum, titanium, zirconium and the rare earths. As used herein, the term “rare earths” means the elements scandium, yttrium, lanthanum and the lanthanides. Both coatings extend the full length of the bulb, completely circumferentially around the bulb inner wall. The stems 10 are free of any of the above coatings. A phosphor coating 17 is disposed over the overcoat layer 16.

The discharge-sustaining filling includes an inert gas such as argon, or a mixture of argon and other gases, at a low pressure in combination with a quantity of mercury to sustain an arc discharge during lamp operation.

According to a particular embodiment, the lamp shown in FIG. 1 is an F34T12 ECONOWATT lamp.

With reference to FIG. 2, there is illustrated a schematic sectional view of a U-bent lamp unit 1A with an elongated lamp vessel, or bulb, 3A having leg segments 4 and a U-shaped section 4A. The bulb is of a conventional soda-lime glass. The lamp includes an electrode mount structure 5A ending in a mount stem 10A of a conventional lead-containing glass which seals the envelope in a gas tight manner. The lamp leads (not shown) are connected to the pin-shaped contacts 13A of their respective bases fixed at opposite ends of the lamp.

According to a particular embodiment, the sectional view shown in FIG. 2 is a segment of a T12TLU fluorescent lamp although it may also be a PL, Circleline, or SLS fluorescent lamp.

### EXAMPLE

A F34T12 ECONOWATT lamp was manufactured according to the invention employing about 4.4 mg of mercury and a phosphor coating of a mixture of about 94 wt % of a cool-white halophosphate, about 2.3 wt % of a red-emitting YOX, about 2.6 wt % of a green-emitting LAP, and about 1.1 wt % of a blue-emitting BAM.

The total amount of bound mercury in lamps derived from the above phosphor blend will not exceed 1.24 mg after 2500 hours operating hours. Based on historical data in our laboratories, the lamps will meet the rated life of 20,000 hours. In addition, the lamps pass the TCLP test and are considered non-hazardous and may be disposed in landfills.

It will be understood that the above discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

(a) the words “comprises” and “comprising” do not exclude the presence of other elements or acts not listed in a given claim;

(b) the word “a” or “an” preceding an element does not exclude the presence of a plurality of such elements;

(c) any reference signs in the claims do not limit their scope; and

(d) several “means” may be represented by the same item or hardware or software implemented structure or function.

1. An electric lamp which comprises:
a lamp envelope having an inner surface;
means within the lamp envelope for generating ultraviolet radiation; and
a layer of a luminescent material on said inner surface comprising a phosphor derived from a mixture of a cool-white calcium halophosphate, a red-emitting yttrium oxide (YOX), a green-emitting cerium, terbium lanthanum phosphate (LAP), and a blue-emitting europium-activated barium magnesium hexa-aluminate (BAM).

2. A lamp as claimed in claim 1, wherein a cerium, terbium magnesium hexa-aluminate (CAT) component, or a cerium, terbium, gadolinium pentaborate (CBT) component is substituted for the green-emitting (LAP) component.

3. A lamp as claimed in claim 1, wherein a divalent europium-activated chloro-strontium, calcium, barium phosphate (SCA) component, or a divalent europium activated strontium chlorophosphate (apatite) (SCAP) component is substituted for the
BAM component.

4. A lamp as claimed in claim 1, wherein said phosphor comprises from about 85 wt % to about 96 wt % of a cool-white calcium halophosphate, from about 1.6 to about 5.8 wt % of a red-emitting yttrium oxide (YOX), from about 1.7 to about 6.5 wt % of a green-emitting cerium, terbium lanthanum phosphate (LAP), and from about 0.7 to about 2.7 wt % of a blue-emitting europium-activated barium magnesium hexa-aluminate (BAM).

5. A low pressure low-mercury consumption mercury vapor fluorescent lamp, comprising:
a. a tubular, light transmissive lamp envelope having opposing sealed ends, an inner tubular surface and enclosing a discharge space between said sealed ends with a volume;
b. a filling of elemental mercury and a rare gas;
c. a pair of discharge electrodes each arranged at a respective sealed end of said lamp envelope;
d. means for connecting said discharge electrodes to a source of electric potential outside of said lamp envelope, whereby during lamp operation a gas discharge is maintained between said discharge electrodes, which gas discharge emits ultraviolet radiation;
e. optionally, a first, light transmissive and ultraviolet radiation reflecting layer disposed adjacent said inner surface of said lamp envelope, and
f. a layer of a luminescent material comprising a phosphor derived from a mixture of a cool-white calcium halophosphate, a red-emitting yttrium oxide (YOX), a green-emitting cerium, terbium lanthanum phosphate (LAP), and a blue-emitting europium-activated barium magnesium hexa-aluminate (BAM).

6. A lamp as claimed in claim 5, wherein said phosphor comprises from about 85 wt % to about 96 wt % of a cool-white calcium halophosphate, from about 1.6 to about 5.8 wt % of a red-emitting yttrium oxide (YOX), from about 1.7 to about 6.5 wt % of a green-emitting cerium, terbium lanthanum phosphate (LAP), and from about 0.7 to about 2.7 wt % of a blue-emitting europium-activated barium magnesium hexa-aluminate (BAM).

7. A lamp as claimed in claim 6, wherein a conductive semiconductor layer of tin oxide is applied as a starting aid between the inner surface and the precoat layer.

8. A low-mercury consumption mercury vapor fluorescent lamp, comprising:
a. a tubular, light transmissive lamp envelope having opposing sealed ends, an inner tubular surface and enclosing a discharge space between said sealed ends with a volume;
b. a filling of elemental mercury and a rare gas;
c. a pair of discharge electrodes each arranged at a respective sealed end of said lamp envelope;
d. means for connecting said discharge electrodes to a source of electric potential outside of said lamp envelope, whereby during lamp operation a gas discharge is maintained between said discharge electrodes, which gas discharge emits ultraviolet radiation;
e. optionally, a first, light transmissive and ultraviolet radiation reflecting pre-coat layer disposed adjacent said inner surface of said lamp envelope;
f. optionally, a conductive semiconductor layer of tin oxide applied as a starting aid between the inner surface and the precoat layer; and
g. a layer of a luminescent material comprising a phosphor derived from a mixture comprising from about 85 wt % to about 96 wt % of a cool-white calcium halophosphate, from about 1.6 to about 5.8 wt % of a red-emitting yttrium oxide (YOX), from about 1.7 to about 6.5 wt % of a green-emitting cerium, terbium lanthanum phosphate (LAP), and from about 0.7 to about 2.7 wt % of a blue-emitting europium-activated barium magnesium hexa-aluminate (BAM).

9. A lamp as claimed in claim 8, wherein said envelope is convoluted and is selected from the group of envelopes comprising at least two leg segments joined by a bent-U section, and envelopes bent to a desired shape.

10. A phosphor blend for low-mercury consumption fluorescent lamps which comprises a mixture of a cool-white calcium halophosphate, a red-emitting yttrium oxide (YOX), a green-emitting cerium, terbium lanthanum phosphate (LAP), and a blue-emitting europium-activated barium magnesium hexa-aluminate (BAM).

11. A phosphor blend as claimed in claim 10, wherein said phosphor comprises a mixture of from about 85 wt % to about 96 wt % of a cool-white calcium halophosphate, from about 1.6 to about 5.8 wt % of a red-emitting yttrium oxide (YOX), from about 1.7 to about 6.5 wt % of a green-emitting cerium, terbium lanthanum phosphate (LAP), and from about 0.7 to about 2.7 wt % of a blue-emitting europium-activated barium magnesium hexa-aluminate (BAM).

12. A phosphor blend as claimed in claim 11, wherein a cerium, terbium magnesium hexa-aluminate (CAT) component or a cerium, terbium, gadolinium pentaborate (CBT) component is substituted for the green-emitting (LAP) component.

13. A phosphor blend as claimed in claim 11, wherein a divalent europium-activated chloro-strontium, calcium, barium phosphate (SCA) component, or a divalent europium activated strontium chlorophosphate (apatite) (SCAP) component is substituted for the BAM component.
